(19) United States
(12) Patent Application Publication
(10) Pub. No.: US 2007/0054015 A1
(43) Pub. Date: Mar. 8, 2007

(54) Method and apparatus for filling high-viscous ice cream into a receptacle

(75) Inventor: Ejvind Waldstrøm, Risskov (DK)

Correspondence Address: CANTOR COLBURN, LLP, 55 GRIFFIN ROAD SOUTH, BLOOMFIELD, CT, 06002, US

(73) Assignee: TETRA PAK HOYER A/S, Hojbjerg (DK)

(21) Appl. No.: 10/572,273

(22) PCT Filed: Sep. 14, 2004
(86) PCT No.: PCT/DK04/00607

§ 371 Date: Mar. 15, 2006

(30) Foreign Application Priority Data
Sep. 16, 2003 (DK) PA 2003 01337

(51) Int. Cl. A23L 1/27

(52) U.S. Cl. 426/249

(57) ABSTRACT

The present invention concerns a method and an apparatus for filling of preferably high-viscous ice cream into receptacles, comprising supplying a substantially constant flow of ice cream to a filling apparatus, which in a flow channel leads to an outlet for successive filling of the receptacles, reducing the flow volume of the flow channel during filling of a receptacle with the outflowing ice cream by means of telescopic displacement of two tube sections, which forms the flow channel, cutting the ice cream hanging out, when the filling of the given receptacle has ended, and subsequently increasing the flow volume, while the subsequent receptacle is being positioned relative to the outlet for filling. Thus a controlled acceleration and outflow velocity of the ice cream is achieved, whereby filling of high-viscous ice cream can be performed rapidly and with significant geometrical accuracy.

The present invention relates to a method and an apparatus for filling substantially high-viscous ice cream into a receptacle.

The filling of ice cream into a packing unit, such as a container, a cone or the like open top receptacle, take the form of intermittently conveying the receptacle into a position under a filling apparatus. During standstill of the receptacle, the outflow from the filling apparatus is filling the receptacle with a predetermined amount, typically a complete fill up, and the top finalization is typically performed with a specified geometry, if desired having a decorative pattern or shape, and finally the ice cream strand is broken and the filling apparatus is lifted from the receptacle in such a way as for the receptacle to be moved forward without the top edges of it is being touched by the ice cream.

For filling normal ice cream, i.e. in the temperature range of ÷4 to ÷7° C., where the viscosity is relatively low, known filling apparatus are used. However, is has become apparent, that these apparatus are not suited for filling of stiff ice cream, i.e. in the temperature range from ÷10 to ÷18° C., where the viscosity is significantly higher.

At least three principles for filling of normal ice cream are known.

The first principle is called “time-elapse”-filling. According to this first principle, the outflow is turned on and off by means of a valve. As the inflow of ice cream for the preceding ice cream freezer is nearly constant, the pressure increases during the closure period. The ice cream contains a certain amount of air, making it compressible. The increased pressure being built up during the closure period contributes to an increased acceleration when the valve opens again, and thus to a quick filling. In the outflow opening, constant geometrical constraints often exist, which are necessary in order to obtain a filling pattern or shape as desired, mainly by the filling finalization at the top of the receptacle.

The second known principle is known as “extrusion-filling”. By this principle, the ice cream flows out with an almost constant velocity of the filling apparatus, in which a cutting mechanism cuts off the ice cream into uniform portions. During filling into a packing unit, the feasible filling time is only going to account for approximately 50% of the cycle time, i.e. the time period between the conveying of one receptacle/packing unit and a subsequent one. During the remaining time period, while a subsequent packing unit is being conveyed, ice cream will flow out of the filling apparatus in an amount being equivalent to approximately 50% of the filling volume. During the subsequent filling, this amount of ice cream hanging under the filling apparatus is fed down into the packing unit, the filling apparatus being lowered down towards the packing unit, and the filling is ended by an upward movement, after which the ice cream is cut off at the upper edge of the packing unit. The third known principle is known as “piston filling”, and U.S. Pat. No. 2,965,141 (O. G. Höyer) discloses a filling machine for filling of normal ice cream into receptacles based this third principle, where pistons are used to deliver pressurized ice cream. A further description of said principle may be found in e.g. U.S. Pat. No. 5,816,455 and U.S. Pat. No. 5,738,895.

The reason why these known principles are not applicable for filling of stiff ice cream is the high viscosity of the ice cream, inducing a very high pressure increase by the compression, which results from valve closure or piston halt, and a subsequent uncontrollable outflow, when the valve is opened or the piston is moved again. Furthermore, by the known extrusion-filling of stiff ice cream, it is very difficult to control the filling out of the packing unit owing to the high-viscous portion hanging under the filling apparatus at the start of the filling process.

By the known techniques and filling of stiff ice cream, it is difficult to obtain a satisfying finalization and filling geometry. By certain (receptacle) packing unit geometries, the outflow volume will be reduced resulting from the fact that the high-viscous ice cream is made to flow through a tube having a reduced outflow opening cross section, which is necessary in order to obtain a good filling geometry at the top of the receptacle. The reduced volume outflow limits the capacity of the machine or increases the spillage.

On this background, it is the object of the present invention to provide a method and an apparatus for filling of stiff ice cream, i.e. ice cream with a high viscosity, in a receptacle, reducing or indeed eliminating the above mentioned disadvantages in relation to the known filling principles.

This is achieved by a method and an apparatus for filling of preferably high-viscous ice cream into receptacles, comprising supplying a substantially constant flow of ice cream to a filling apparatus, which in a flow channel leads to an outlet for successive filling of the receptacles, reducing the flow volume of the flow channel during filling of a receptacle with the outflowing ice cream, cutting the ice cream hanging out, when the filling of the given receptacle has ended, and subsequently increasing the flow volume, while the subsequent receptacle is being positioned relative to the outlet for filling.

By a filling apparatus according to the invention, the apparatus is provided with an inlet being supplied by a substantially constant flow of ice cream and an outlet for successive filling of receptacles, where the apparatus between the inlet and outlet exhibit a flow channel constituted by two mutually telescopically displaceable tube sections, said apparatus further comprising means for variation of the volume of the flow channel comprising drive means for positioning of the tube sections in relation to a subjacent receptacle, wherein the means for variation of the volume of the flow channel comprises drive means for displacement of the tube sections relative to each other, and said apparatus further comprising means for controlling the flow volume in the flow channel.

Said means for volume variation is constituted by a slide tube section being positioned externally of a filling tube, alternatively further comprising an ousting element being positioned internally of said filling tube, in such a way, that the slide tube section and the filling tube can be displaced telescopically relative to each other by means of drive means. The total internal volume of the flow channel is thus variable according to a predetermined sequence. This enables a halt of the ice cream flowing out by increasing the internal volume at a velocity, which corresponds to the constant inflow of ice cream, or alternatively a back suction of ice cream up into the filling apparatus by a faster displacement. At the subsequent start of a new filling, the internal volume of the flow channel is reduced whereby a controlled acceleration and outflow velocity of the ice cream is achievable. Thus, filling of high-viscous ice cream can be performed rapidly and with significant geometrical accuracy. By the invention it has further been realized, that the filling method according to the invention may also be utilized for filling of ice cream with relatively low viscosity, e.g. normal ice cream, which may be advantageous, if a reduced compression of the ice cream is desired or a compression is to be avoided.

At the end of the filling, at the top of the receptacle, the internal volume of the flow channel is increased, such that the outflow from here is halted or, alternatively, a “retraction” of the ice cream is performed, whereby the cross section is reducing. In connection herewith, a cutting of the ice cream rod is performed using cutting means, such as a cutting wire being arranged on a revolvable or displaceable arm in front of the outflow nozzle. Thus, a resulting effect is that the top of the ice cream filling can be finalized under the top edge of the packing unit. By the invention it has been realized, that the cutting means alternatively may be implemented as shearing means or other types of cutting devices.

At the end of filling, in order to obtain a controlled geometry pattern or shape, a number of form elements may be arranged at the outflow nozzle, said form elements being pivotable, turnable or displaceable from around the periphery of the outlet and towards the centre of the outlet, for forming the cross section of the outflowing ice cream. By a controlled movement of these form elements the cross section of the outlet is reduceable, and a variably indented outlet opening is thereby produced, which is able to generate a cross section geometry in the outflowing stiff ice cream or even able to completely close the outflow opening. The cross section (area) of the outlet may thus be maintained at maximum dimensions during filling of the main part of the high-viscous ice cream, which in turn will increase the capacity of the machine, and at the same time the cross section is reduceable during the final filling phase.

In the following, the present invention is described in further detail referring to the appended drawing material, wherein:

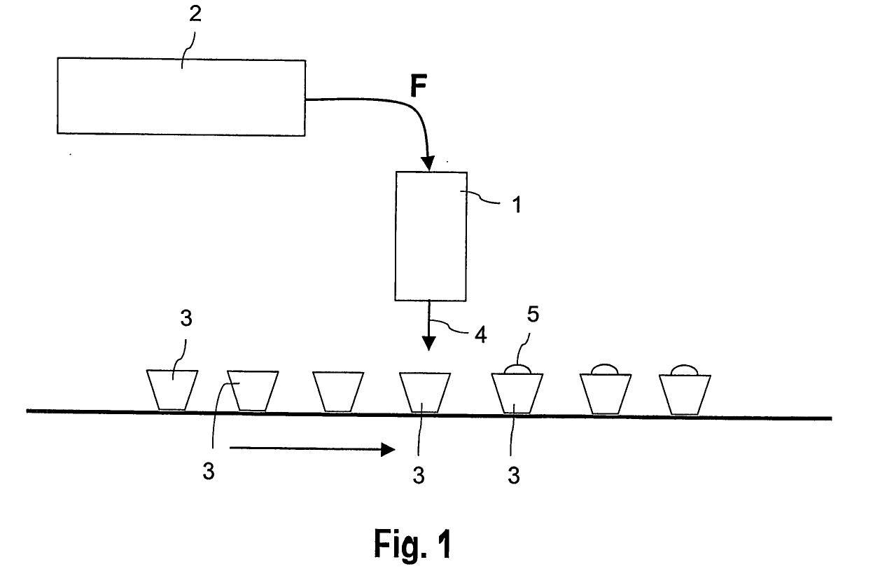

FIG. 1 shows a schematic view of the filling process;

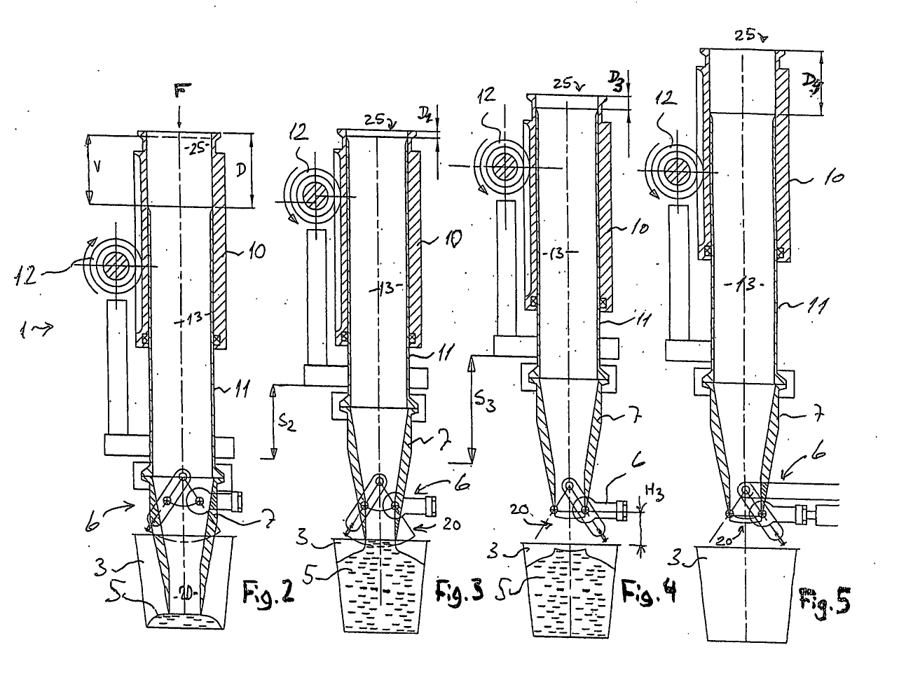

FIG. 2 to 5 show four process steps in a filling process and a filling apparatus according to the invention;

FIG. 6, 7 show a sectional view from the side and a view from one end of an outlet nozzle having form lamellae according to a preferred embodiment, where the lamellae are in a passive position; and

FIG. 8, 9 show the same in their active position.

As shown in FIG. 1, the filling process for packing receptacles for ice cream is performed by the receptacles 3 intermittently being conveyed on a conveyor as indicated by the arrow S. In a filling station, the receptacle 3 is brought under a filling apparatus 1, from which the ice cream flows, as indicated with arrow 4, and the receptacle 3 is filled with ice cream 5. The ice cream is fed into the filling apparatus 1 from an ice freezer 2 with a substantially constant inflow velocity F. The receptacles 3 may be cups, cones, or the like ice containers, which are open at the top and contribute to packing the ice cream.

In the FIGS. 2 to 5 is shown a filling cycle by a method according to the invention using a filling apparatus according to a preferred embodiment of the invention. In FIG. 2, the filling apparatus is shown at the start of a filling process according to the invention. FIG. 3 shows the filling process after approx. 50% of the process time has elapsed, FIG. 4 shows the position of the elements in the filling apparatus after approx. 55% of the process time has elapsed, and FIG. 5 shows the filling process, when it is almost at its end, i.e. after approx. 95% of the process time has elapsed.

A first tube section 10 is arranged as a glide tube externally on a second tube section 11 acting as a filling tube. The two tube sections 10, 11 are telescopically displaceable in relation to each other and are able to be positioned in relation to the receptacle under the filling apparatus 1 by means of a drive mechanism 12, which in the preferred embodiment may be a servo motor, e.g. an AC motor. The first tube section 10 exhibits an inlet 25, and the second tube section 11 is at the lower part provided with an outlet nozzle 7 with an outlet opening 20. Combined, the two tube sections 10, 11 form a flow channel 13, through which the ice cream, which is flowing with a substantially constant velocity, can be filled into the receptacle 3.

A filling of the receptacle is started, as shown in FIG. 2, by the outlet nozzle 7 being led into the receptacle 3 and the top edge of the second tube section 11 being positioned at a distance D from the top of the slide tube 10, and by the filling tube 11 hereby is moved onwards in relation to the slide tube 10 to a distance V, which corresponds to approx. 50% of the amount of the ice cream, which is going to be filled into the receptacle 3. Then, the receptacle 3 is gradually filled by the filling tube 11, while this is being pulled gradually into the slide tube 10, which at the same time is being lifted upwards, whereby the interior volume of the flow channel 13 is decreasing during filling. When the filling has been completed, the slide tube 10 has been elevated to a distance D₂ above the filling tube 11, while the nozzle at the same time has been elevated upwards to a distance S₂ (see FIG. 3).

After filling the cutting device 6 is actuated, which preferably exhibits a cutting wire swingably suspended between two arms, which are swung back and forth for cutting of the ice cream 5 at the same time as the tube sections 10, 11 are further elevated up to a distance S₃ into a position as shown in FIG. 4, the two tube section 10, 11 simultaneously being further displaced from each other as shown by the distance D₃. Moreover, the opening 20 of the nozzle 7 is at the same time raised to a height H₃ over the top edge of the receptacle, as shown in FIG. 4. The interior volume of the flow channel 13 is hereby increased at a sufficient rate for the ice cream not to flow out of the outlet nozzle 7.

The interior volume is kept increasing, even after the nozzle is lifted with a clearance from the receptacle 3 by means of the slide tube 10 is led further backwards to a distance D₄ between the top edges of the tube sections 10, 11 at the same time as the filled receptacle is being led away and a new receptacle to be filled is led in under the filling apparatus 1, as it is shown in FIG. 5. Thus, the filling process is about to be ended and may then be repeated for the new receptacle 3 by means of the tube sections 10, 11 again is drawn into each other and the nozzle is led into the new receptacle, thus decreasing the volume of the flow channel 13 and the outlet velocity of the ice cream through the nozzle opening 20 may be controlled to a velocity amounting to approximately twice that of the inlet velocity F of the ice cream.

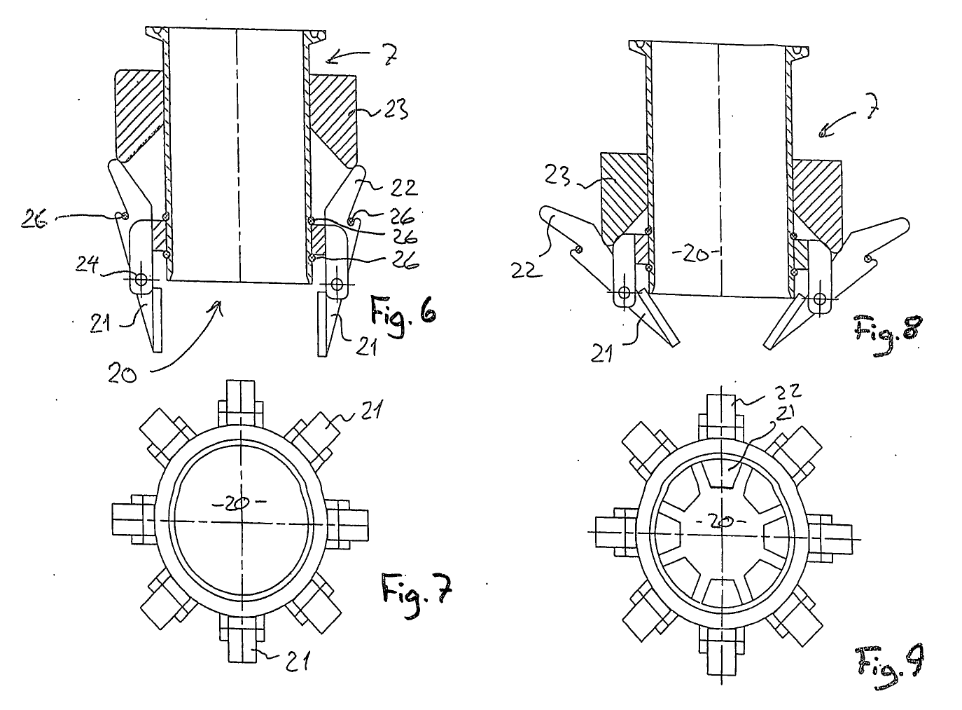

In the FIGS. 6 to 9 are shown a sectional view and an end view, respectively, of an outlet nozzle 7 according to a preferred embodiment of the invention. The nozzle 7 is provided with form lamellae 21, which are arranged along the periphery of the nozzle opening 20. Each of the form lamellae 21 are pivotally arranged around a rotation axis 24 and exhibit an inclining actuating portion 22, which through an inclining face cooperates with a annular actuating element 23, which pivots the form lamellae 21 into the nozzle opening 20 by an axial displacement. In FIG. 6 the nozzle opening 20 with form lamellae 21 is shown in a passive position and in FIG. 8 the same is shown in an active position with the form lamellae 21 pivoted in. The form lamellae 21 are provided with spring means 26, ensuring contact between the inclining face and the actuation element 23, whereby is ensured that the form lamellae pivots back again to an axial displacement of the actuating element 23 in the upwards direction. In the FIGS. 7 and 9 the nozzle opening is shown from below in the passive and active position, respectively. The lamellae 21 may be designed with different geometries as to which decorative cross section pattern or shape is desired for the outflowing ice cream strand. Further, it has by the invention been realised, that the lamellae 21 may also be designed and operated in such a way as to be used for completely closing the nozzle opening 20, if this is desired.

Above, the invention is described referring to a preferred embodiment, in which the directions being used in the text, e.g. upwards and downwards, solely are indicating directions in relation to the figures and by no means intended to limit the scope of the invention. It has by the invention been realised, that variations or equivalent solutions for the invention may be conceived belonging within the scope of protection for the invention as defined in the attached claims.

1. A method for filling of preferably high-viscous ice cream into receptacles, comprising:
supplying a substantially constant flow of ice cream to a filling apparatus, which in a flow channel leads to an outlet for successive filling of the receptacles;
reducing the flow volume of the flow channel during filling of a receptacle with the outflowing ice cream by means of telescopic displacement of two tube sections, which forms the flow channel;
cutting the ice cream hanging out, when the filling of the given receptacle has ended; and
subsequently increasing the flow volume, while the subsequent receptacle is being positioned relative to the outlet for filling.

2. A method according to claim 1, wherein the flow volume further is varied by displacement of an ousting element in the flow channel.

3. A method according to claim 1, wherein the outflowing of ice cream is controlled by a process control, such that a rate of change of flow volume is controlled within an interval.

4. A method according to claim 3, wherein the flow volume is reducible such that the outflowing volume is substantially doubled in proportion to the inflowing volume of ice cream.

5. A method according to claim 3, wherein the flow volume is increasable such that the outflowing volume substantially stops or is retracted, while the inflowing volume of ice cream is substantially constant.

6. An apparatus for filling of preferably high-viscous ice cream into receptacles, comprising:
an inlet being supplied by a substantially constant flow of ice cream and an outlet for successive filling of receptacles, where the apparatus between the inlet and outlet exhibit a flow channel, constituted by two mutually telescopically displaceable tube sections;
means for variation of the volume of the flow channel, said means comprising drive means for displacement of the tube sections relative to each other; and
means for controlling the flow volume in the flow channel.

7. An apparatus according to claim 6, further comprising drive means for positioning of the tube sections in relation to a subjacent receptacle.

8. Apparatus according to claim 6, wherein a first tube section exhibits the inlet to the flow channel and a second tube section exhibits the outlet of the flow channel, said second tube section being concentrically arranged in the first tube section and being provided with an outlet nozzle means, through which the ice cream is conductible down into the receptacle.

9. Apparatus according to claim 7, wherein the drive means is a servo motor, where the nozzle means is positionable for filling of a receptacle by rotation of the motor in a first direction of revolution and the nozzle means then gradually is liftable out from the receptacle by rotation of the motor in the other direction of revolution, and that the two tube sections are mutually displaceable out of each other by rotation of the motor in this second direction of revolution.

10. Apparatus according to claim 6, where an ousting element is arranged in the flow channel, said ousting clement being displaceable in the flow channel for modification of the flow volume therein.

11. Apparatus according to claim 6, wherein a cutting device for cutting the outflowing ice cream is arranged beyond the outlet.

12. An apparatus according to claim 6, wherein the means for controlling the flow volume in the flow channel are able to control a rate of modification of the flow volume inside an interval in such a way that the outlet velocity of the outflowing ice cream is controllable from being zero or even negative to substantially twice the size of the substantially constant inlet velocity of the ice cream to the apparatus.

13. An apparatus according to claim 6, wherein the outlet nozzle is provided with form elements being arranged along a periphery of the outlet by means of which a predetermined and a during the filling sequence controlled geometry of the outflowing ice cream is obtainable.

14. An apparatus according to claim 13, wherein the form elements are arranged movable in such a way as to enable them to be pivoted, turned or radially displaced to an active position, in which they protrude into an opening of the nozzle and to a passive position, in which they are pulled back and thus does not affect the outflowing ice cream.

15. An apparatus according to claim 14, where the form elements are able to move towards or away from a flexible outlet nozzle and thereby by deformation is generating a fixed or variable outlet geometry therein.
